(19) United States
(12) Patent Application Publication
(10) Pub. No.: US 2016/0039338 A1
(43) Pub. Date: Feb. 11, 2016

(54) Alarm Assembly

(71) Applicant: Carlos Keels, Hollywood, FL (US)

(72) Inventor: Carlos Keels, Hollywood, FL (US)

(21) Appl. No.: 14/451,548

(22) Filed: Aug. 5, 2014

(51) Int. Cl. B60Q 5/00; G08B 21/02

(52) U.S. Cl. CPC B60Q 5/005; G08B 21/02

(57) ABSTRACT

An alarm assembly for detecting an occupant left in a parked vehicle includes a plate that may be coupled to a vehicle. A processor is coupled to the plate. The processor is operationally coupled to the vehicle alarm system. A sensor is coupled to the plate. The sensor may detect an occupant in the vehicle after the vehicle is parked. The sensor is operationally coupled to the processor. The vehicle alarm system emits an audible alarm when the sensor detects the occupant in the vehicle after the vehicle is parked.

### BACKGROUND OF THE DISCLOSURE

### Field of the Disclosure

The disclosure relates to alarm devices and more particularly pertains to a new alarm device for detecting an occupant left in a parked vehicle.

### SUMMARY OF THE DISCLOSURE

An embodiment of the disclosure meets the needs presented above by generally comprising a plate that may be coupled to a vehicle. A processor is coupled to the plate. The processor is operationally coupled to the vehicle alarm system. A sensor is coupled to the plate. The sensor may detect an occupant in the vehicle after the vehicle is parked. The sensor is operationally coupled to the processor. The vehicle alarm system emits an audible alarm when the sensor detects the occupant in the vehicle after the vehicle is parked.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a alarm assembly according to an embodiment of the disclosure.

FIG. 2 is a top view of an embodiment of the disclosure.

FIG. 3 is a bottom view of an embodiment of the disclosure.

FIG. 4 is a right side view of an embodiment of the disclosure.

FIG. 5 is an in-use view of an embodiment of the disclosure.

FIG. 6 is a schematic view of an embodiment of the disclosure.

### DESCRIPTION OF THE PREFERRED EMBODIMENT

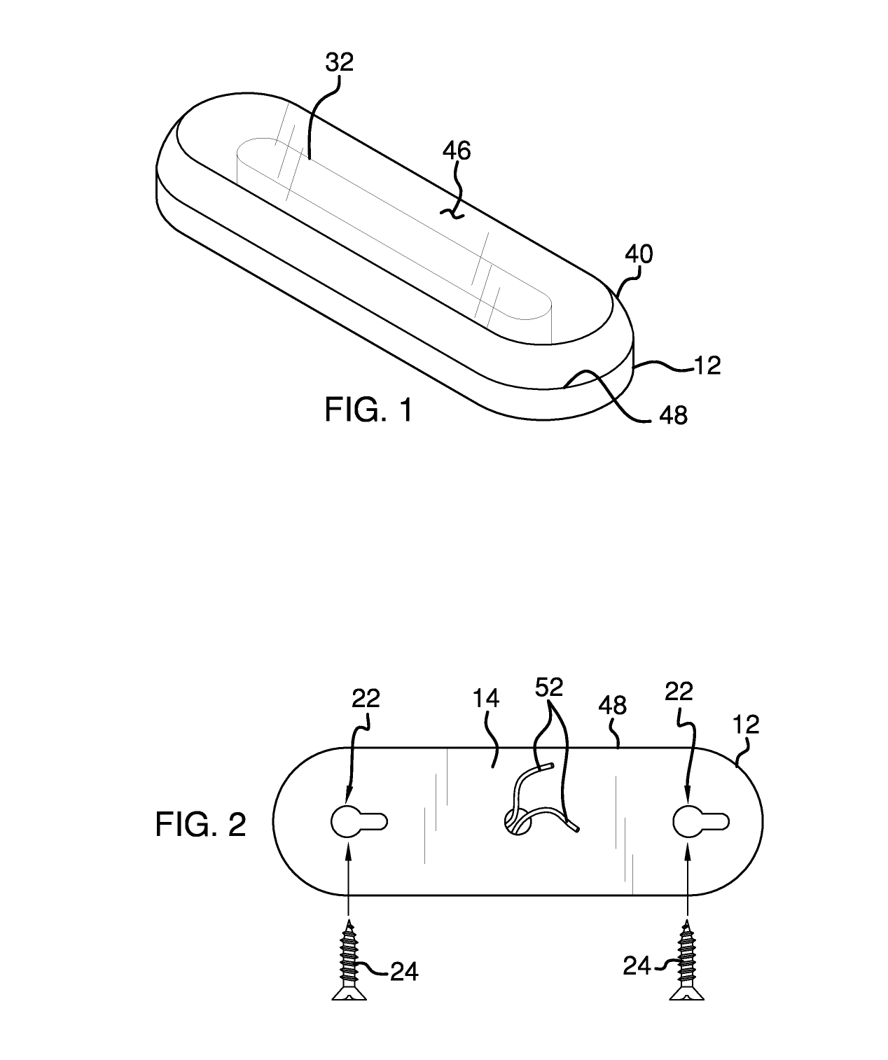

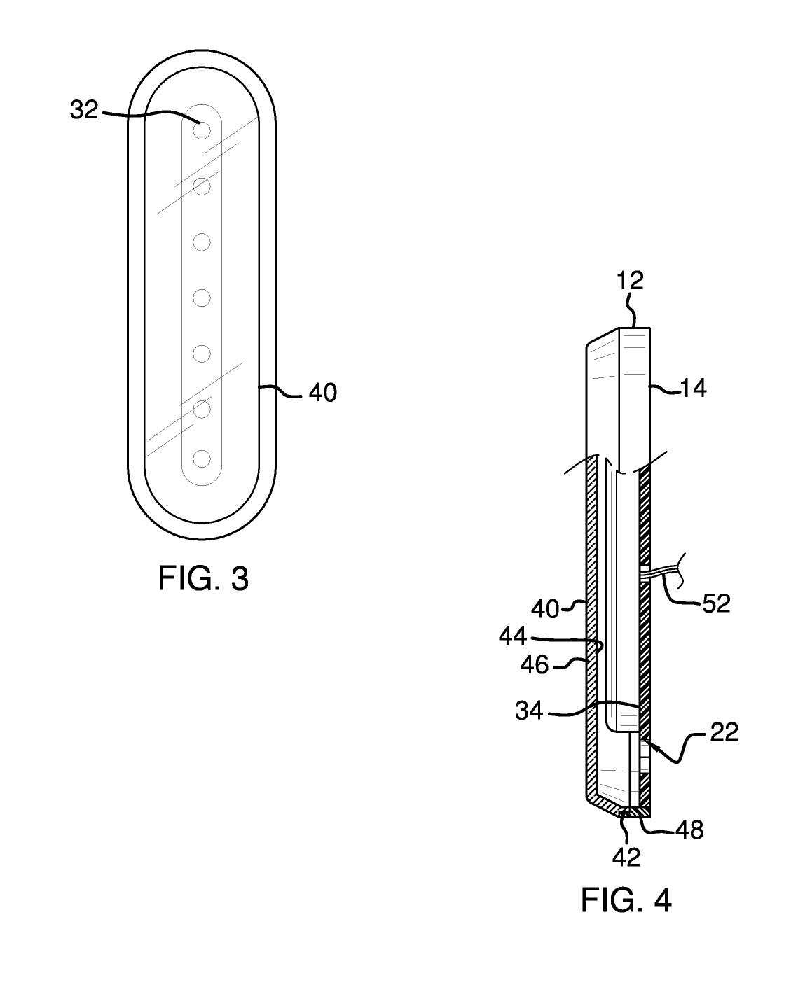

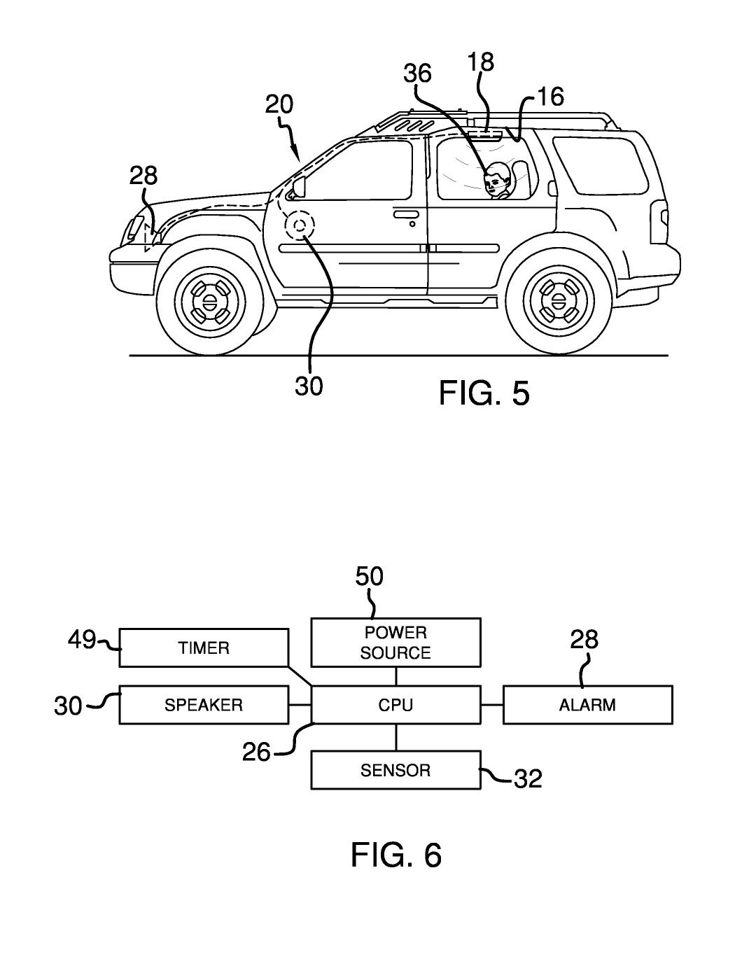

With reference now to the drawings, and in particular to FIGS. 1 through 6 thereof, a new alarm device embodying the principles and concepts of an embodiment of the disclosure and generally designated by the reference numeral 10 will be described.

As best illustrated in FIGS. 1 through 6, the alarm assembly 10 generally comprises a plate 12. A top side 14 of the plate 12 is coupled to an inner surface 16 of a roof 18 of a vehicle 20. The plate 12 is retained within the vehicle 20. The vehicle 20 may be a passenger vehicle of any conventional design. The plate 12 has a pair of fastener apertures 22 extending therethrough. A pair of screws 24 extends through the pair of fastener apertures 22 and engages the inner surface 16 of the roof 18 of the vehicle 20.

A processor 26 is coupled to the plate 12. The processor 26 is electrically coupled to the vehicle's alarm system 28. The processor 26 may be an electronic processor of any conventional design. Additionally, the processor 26 is electrically coupled to a speaker 30 in the vehicle 20. The speaker 30 emits an audible alarm.

A sensor 32 is coupled a bottom side 34 of the plate 12. The sensor 32 is exposed to an interior of the vehicle 20. Moreover, the sensor 32 may detect an occupant 36 in the vehicle 20 after the vehicle 20 is parked. The sensor 32 is electrically coupled to the processor 26. The vehicle alarm system 28 emits an audible alarm when the sensor 32 detects the occupant 36 in the vehicle 20 after the vehicle 20 is parked.

The sensor 32 may be an infra-red sensor of any conventional design. The sensor 32 detects a heat signature of the occupant 36 in the vehicle 20. Additionally, the sensor 32 is one of a plurality of the sensors 38. The sensors 38 are even spaced apart and distributed laterally along the bottom side 34 of the plate 12.

A cover 40 is provided. The cover 40 has an exposed edge 42 extending between an inner surface 44 and an outer surface 46 of the cover 40. The inner 44 and outer 46 surfaces of the cover 40 are curvilinear so the cover 40 has a bowl shape. The cover 40 is removably coupled to the bottom side 34 of the plate 12. Additionally, the exposed edge 42 of the cover 40 is coextensive with an outer edge 48 of the plate 12. The cover 40 may be comprised of a translucent material.

A timer 49 is coupled to the plate 12. The timer 49 is electrically coupled to the processor 26. The timer 49 de-actuates the vehicle alarm system 28 after a pre-determined duration of time has passed. The timer 49 may be an electronic timer of any conventional design.

A power supply 50 is coupled to the plate 12. The power supply 50 is electrically coupled to the processor 26. Additionally, the power supply 50 comprises a pair of conductors 52 extending away from the top side 14 of the plate 12. The power supply 50 is electrically coupled to the vehicle's electrical system 54.

In use, the sensors 38 are actuated after the vehicle 20 is turned off. The vehicle alarm system 28 and the speaker 30 emit an audible alarm if the occupant 36 is detected in the vehicle 20 after the vehicle 20 is shut off. The assembly 10 prevents an infant or other similar individual from being inadvertently left in the vehicle 20.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An alarm assembly comprising:
a plate configured to be coupled to a vehicle, said plate being elongated wherein said plate is configured for being positioned over a back seating area of the vehicle;
a processor coupled to said plate, said processor being operationally coupled to the vehicle alarm system; and
a plurality of sensors even spaced apart and distributed along a longitudinal axis of said plate and along said bottom side of said plate such that each said sensor is exposed to an interior of the vehicle, each said sensor being coupled to said plate such that said sensor is configured to detect an occupant in the vehicle after the vehicle is parked, each said sensor being operationally and electrically coupled to said processor such that the vehicle alarm system emits an audible alarm when said sensor detects the occupant in the vehicle after the vehicle is parked.

2. The assembly according to claim 1, further comprising a top side of said plate being coupled to a inner surface of a roof of the vehicle such that said plate is retained within the vehicle.

3. The alarm assembly according to claim 1, further comprising said processor being electrically coupled to the vehicle alarm system.

4. (canceled)

5. (canceled)

6. (canceled)

7. The alarm assembly according to claim 1, further comprising a power supply coupled to said plate.

8. The alarm assembly according to claim 7, further comprising said power supply being electrically coupled to said processor.

9. The alarm assembly according to claim 8, further comprising said power supply being electrically coupled to the vehicle's electrical system.

10. An alarm assembly comprising:
a plate, a top side of said said plate being coupled to a inner surface of a roof of a vehicle such that said plate is retained within the vehicle, said plate being elongated wherein said plate is configured for being positioned over a back seating area of the vehicle;
a processor coupled to said plate, said processor being electrically coupled to a vehicle alarm system;
a sensor coupled a bottom side of said plate such that said sensor is exposed to an interior of the vehicle wherein said sensor is configured to detect an occupant in the vehicle after the vehicle is parked, said sensor being electrically coupled to said processor such that the vehicle alarm system emits an audible alarm when said sensor detects the occupant in the vehicle after the vehicle is parked, said sensor being one of a plurality of sensors even spaced apart and distributed along a longitudinal axis of said plate and along said bottom side of said plate such that each said sensor is exposed to an interior of the vehicle; and
a power supply coupled to said plate, said power supply being electrically coupled to said processor, said power supply being electrically coupled to the vehicle's electrical system.
